(19) United States
(12) Patent Application Publication
(10) Pub. No.: US 2023/0028730 A1
(43) Pub. Date: Jan. 26, 2023

(54) ARTIFICIAL INTELLIGENCE SYSTEM, ARTIFICIAL INTELLIGENCE PROGRAM, AND NATURAL LANGUAGE PROCESSING SYSTEM

(71) Applicant: ROBOMIND, INC., Hyogo (JP)

(72) Inventor: Atsushi TAKATA, Hyogo (JP)

(73) Assignee: ROBOMIND, INC., Hyogo (JP)

(21) Appl. No.: 17/788,128

(22) PCT Filed: Feb. 9, 2021
(86) PCT No.: PCT/JP2021/004806

§ 371 Date: Jun. 22, 2022

(30) Foreign Application Priority Data
Feb. 14, 2020 (JP) PCT/JP2020/005696

(51) Int. Cl. G06N 3/00; G06F 3/01

(52) U.S. Cl. CPC G06N 3/006; G06F 3/011; G06F 2203/011

(57) ABSTRACT

An artificial intelligence system includes: a storage configured to previously store a data model; a generator configured to extract the data model from the storage and generate a human object capable of reproducing a motion and a thought of a human; a world builder including a first platform and a second platform and configured to construct a world in which a motion and a thought of the human object are developed, the human object being disposed on the first platform and the second platform; the external world reproduction unit configured to dispose the human object on the first platform and reproduce an external world; and an output determiner configured to obtain an external situation by recognizing the external world reproduced on the first platform, dispose the human object on the second platform, and determine an output to the outside by manipulating the human object.

This application claims priority to International Patent Application No. PCT/JP2020/005696, which was filed on Feb. 14, 2020, and is incorporated herein by reference in its entirety.

### TECHNICAL FIELD

The present invention relates to an artificial intelligence system, an artificial intelligence program, and a natural language processing system.

### BACKGROUND ART

Current artificial intelligence has become more intelligent than humans in specific fields such as Go and Shogi. However, even if artificial intelligence can play only Go and Shogi, it is not so useful in real life. Artificial intelligence we want is not specialized in something but can do anything like humans. Such artificial intelligence is called artificial general intelligence.

One feature of artificial intelligence like humans is capability of natural communication, that is, natural conversation, with humans.

### CITATION LIST

### Patent Literature

Patent Literature 1: Japanese Patent Application Laid-Open No. 2006-178063

### SUMMARY OF INVENTION

### Technical Problem

Patent Literature 1 discloses a conversation system that provides a reply suitable for an emotion. This system, however, merely replies to words, and cannot establish a conversation.

There are other AIs enabling a conversation, such as AI loudspeakers and smartphone applications. These AIs, however, merely reproduce previously prepared scenarios, and do not make natural conversations or small talks. Humans can make natural conversations because they think about various things in mind during conversations, such as understanding unexplicit meaning exemplified by inferring and considering the other person's intentions, and expecting the other's thought in response to their own utterance. Merely speaking a previously prepared scenario is insufficient for a natural conversation.

It is therefore an object of the present invention is to provide an artificial intelligence system that can understand the other's emotion and behave as if the system has a mind similar to that of a person with social skills.

### Solution to Problems

An artificial intelligence system according to the present invention is an artificial intelligence system that determines an output to outside based on input from the outside.

An artificial intelligence system includes: a storage configured to previously store a data model imitating a human and a thought of a human; a generator configured to extract the data model from the storage and generate a human object capable of reproducing a motion and a thought of a human; a world builder including a first platform and a second platform and configured to construct a world in which a motion and a thought of the human object are developed, the human object being disposed on the first platform and the second platform; the external world reproduction unit configured to dispose the human object on the first platform and reproduce an external world, based on the information input from the outside; and an output determiner configured to obtain an external situation by recognizing the external world reproduced on the first platform, dispose the human object on the second platform, and determine an output to the outside by manipulating the human object.

With this configuration, the output determiner recognizes an external world from the first platform. That is, since a person outside is recognized as a human object, it is possible to know even thought contents of the person that cannot be obtained by a camera or the like. In addition, thought of a partner in response to an action can be simulated by using the second platform, and a natural response can be made.

In the artificial intelligence system, the human object of each of a self and a partner may be disposed on the first platform and the second platform, and the output determiner may determine an output such that a thought of the human object of the partner is felt favorable. With this configuration, it is possible to provide artificial intelligence that is more considerate of the partner and behaves as if the artificial intelligence has the same mind as humans.

In the artificial intelligence system, the human object disposed on the first platform may include a lower first platform corresponding to the first platform of the human, and the world builder may reproduce the external world on the lower first platform based on information input about the human. This configuration enables the system to think in the position of a partner and to communicate with a person more naturally.

In the artificial intelligence system, the data model of the human may have two types of desires, the two types of desires being a low level desire generated from body and a high level desire to achieve a socially valuable thing, and the output determiner may determine an output such that the low level desire is suppressed and the high level desire is satisfied. This configuration enables the artificial intelligence system to determine “should do” and virtue or evil, to have a natural conversation with a person, and to fit in with human society.

An artificial intelligence program according to the present invention is an artificial intelligence program configured to determine an output to outside based on information input from the outside, and the artificial intelligence program is configured to cause a computer to function as: a generator configured to generate a human object capable of reproducing a motion and a thought of a human, from a data model imitating a human and a thought of a human; a world builder including a first platform and a second platform and configured to construct a world in which a motion and a thought of the human object are developed, the human object being disposed on the first platform and the second platform; the external world reproduction unit configured to dispose the human object on the first platform and reproduce an external world, based on the information input from the outside; and an output determiner configured to obtain the external world by recognizing the external world reproduced on the first platform, dispose the human object on the second platform, and determine an output to the outside by manipulating the human object.

With this configuration, the output determiner recognizes the external world from the first platform. That is, since a person outside is recognized as a human object, it is possible to recognize even thought contents of the person that cannot be obtained by a camera or the like. In addition, thought of a partner in response to an action can be simulated by using the second platform, and a natural response can be made.

Here, words spoken by humans are called natural language, and the field of artificial intelligence dealing with natural language is called natural language processing. A biggest problem of natural language processing is incapability of understanding meaning of sentences. Thus, conversation AI only speaks a previously prepared scenario and cannot make a natural conversation.

It is therefore another object of the present invention to provide a technique for understanding meaning of natural language.

A natural language processing system according the present invention is a natural language processing system including: an input device configured to receive a sentence of natural language, a storage device configured to store an object representing a human or a thing, and a controller configured to disassemble an input sentence from the input device to words and analyze meaning, the storage device stores the object and a name of the object in association with each other, and the controller generates the object based on the words of the input sentence and the storage device and changes the object based on the words of the input sentence to thereby analyze meaning.

A word is extracted from a character string of natural language and an attribute of an object is changed so that a state close to a real person or thing can be reproduced by a computer. That is, the object is allowed to have the same attributes and motion as those of a real person or thing within the computer. Then, it can be said that meaning of a sentence of natural language is understood.

### Effects of the Invention

Such an artificial intelligence system can understand the other's emotion, behave as if the system has a mind similar to that of a person, and fit in with human society.

### BRIEF DESCRIPTION OF DRAWINGS

FIG. 1 is a block diagram illustrating a configuration of an artificial intelligence system according to a first embodiment.

FIG. 2 is a conceptual illustration of configurations of a first platform and a second platform in the artificial intelligence system according to the first embodiment of the present disclosure.

FIG. 3 is a flowchart depicting a typical process in processing by an artificial intelligence system of this disclosure.

FIG. 4 is a conceptual illustration of the second platform on which a robot is placed in a room.

FIG. 5 is a conceptual illustration of the second platform on which the robot is placed in the room.

FIG. 6 is a conceptual illustration of the second platform on which the robot is placed in the room.

FIG. 7 is a flowchart depicting a typical process in processing by the artificial intelligence system of the present disclosure.

FIG. 8 is a table used for judgement of virtue and evil by a should-do determination program.

FIG. 9 is a table used for judgement of social virtue and evil by the should-do determination program.

FIG. 10 is a table used for judgement of individual action by the should-do determination program.

FIG. 11 is a conceptual illustration of a configuration of an artificial intelligence system according to anther embodiment of this disclosure.

### DESCRIPTION OF EMBODIMENTS

### Details of Embodiments of the Present Invention

One embodiment of an artificial intelligence system according to the present disclosure will now be described with reference to the drawings. In the following drawings, the same or corresponding parts are denoted by the same reference numerals, and the description thereof will not be repeated.

### First Embodiment

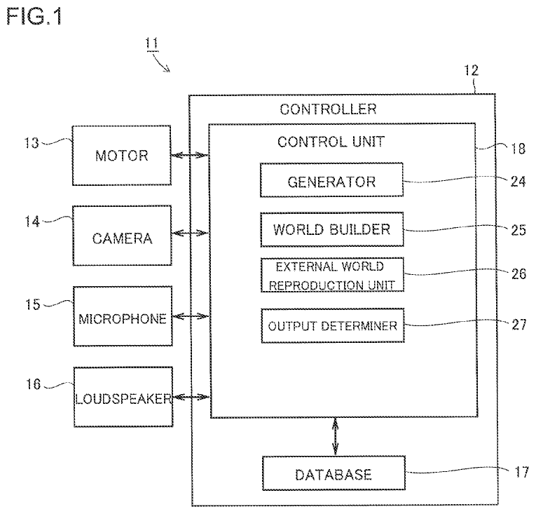

A configuration of an artificial intelligence system according to a first embodiment of the present disclosure will be described. FIG. 1 is a block diagram illustrating the configuration of the artificial intelligence system according to the first embodiment.

An artificial intelligence system 11 according to the first embodiment is applicable to a robot including a controller 12. The configuration of the robot includes a body similar to that of a human. That is, the robot has parts corresponding to hands and feet of a human and includes a motor 13 for driving these parts. The robot also includes a camera 14 corresponding to an eye of a human, and the camera 14 captures an image of the outside to acquire video data. The robot also includes a microphone (member having a sound collecting function) 15 corresponding to an ear of a human, and the microphone 15 obtains external sound and voice. The robot also includes a loudspeaker 16 corresponding to the mouth of a human, and the loudspeaker 16 makes an utterance for conversation. The controller 12 controls the foregoing parts, and executes an artificial intelligence program. The artificial intelligence program controls the motor 13 for moving hands and feet and the loudspeaker 16 for making an utterance, based on external information obtained from the camera 14 and the microphone 15. That is, the artificial intelligence program determines an action of the robot itself based on external information. The controller 12 includes a central processing unit (CPU) and a main storage memory to be loaded with an artificial intelligence program according to the present disclosure.

The artificial intelligence system 11 is an artificial intelligence system that determines an output to the outside based on information input from the outside. The artificial intelligence system 11 includes the controller 12 including a control unit 18, and also includes a database 17 serving as a storage for previously storing data models of a person, an object, and so forth. The control unit 18 determines an output to the outside such as the motor 13 and the loudspeaker 16, based on information input from the camera 14 and the microphone 15.

The control unit 18 includes a generator 24 for generating an object from a data model, a world builder 25, an external world reproduction unit 26, and an output determiner 27 for determining an output.

The data model represents a person, a thing, an idea, and so forth, and is stored in the database 17. When a person or a thing is recognized based on external information from the camera 14 and the microphone 15, the control unit 18 extracts a corresponding data model by the external world reproduction unit 26, generates an object by the generator 24, and disposes the object in the world builder 25, thereby constituting a world. The object is the same as an object of object-oriented language, is freely operable, and is generated on a memory.

The artificial intelligence system 11 is a system capable of making a natural conversation and a natural dialog with a person. Thus, the artificial intelligence system 11 has the function of receiving a voice of a partner in conversation through microphone 15 and converting voice data to a character string (text data) of natural language in real time. Data to be input is not limited to a conversation voice from the microphone 15, and may be a text of natural language obtained by the camera 14. In this case, the text is converted to a character string of natural language by image character recognition. The input is not limited to a text, and is understood by recognizing a situation from a scene in front of the camera 14 in some cases. Such cases will be described later.

The artificial intelligence system 11 can be used as a natural language processing system for general purpose in the case of understanding meaning of natural language in not only conversations and dialogs with humans but also summary and machine translation of a text.

A method for understanding meaning of natural language according to the present invention will now be described. A most important feature of understanding of meaning according to the present invention is to express a person or a thing in the real world as an object. An object refers to an object of object-oriented language, and can be a model resembling a thing or a person in the real world.

An object has a property representing a character and an attribute of a thing and a method showing a motion of the thing. For example, in the case of an apple object, a shape property is round or spherical, and a color property is red. A thing also has a location property. A human object has, for example, a name property, a sex property, and an address property. A method includes work, run, eat, and so forth. An object is written as a class in a program, and generated as an object in a heap area of a memory. These objects are managed in a word dictionary in correspondence with words of natural language. The word dictionary is stored in the database 17, a storage device such as a hard disk drive (HDD), or a main memory. For example, an apple class corresponds to a word such as “apple” and is managed in a word dictionary.

An object represents a person or a thing, and is disposed in a world or a space corresponding to the person or the thing. A simple example is a three-dimensional space. The three-dimensional space is a space created by virtually simulating a real three-dimensional space in a computer, and is created by, for example, three-dimensional computer graphics (3DCG). The three-dimensional space may be created only by a wire frame.

Understanding of meaning of natural language will now be described. Supposing that a natural language sentence “There is an apple in contact with the upper surface of the table.” is input. First, the input sentence is decomposed into words by morphological analysis. Then, the sentence is decomposed into “there/is/an/apple/in/contact/with/the/upper/surface/of/the/table.” Here, “table” is extracted and is searched for in the word dictionary, and when “table” is found, a table object is created. Similarly, an apple object is created. This means that meaning of natural language, such as “table” and “apple,” is understood.

Next, the verb “is” in “There is a table.” and “There is an apple.” means existence of a thing. Thus, these things are placed in a three-dimensional space. This means that the meaning of a verb of natural language “There is a thing.” is understood.

The word “upper” refers to a direction opposite to the gravity. In 3DCG, the gravity can also be simulated, and the direction of the gravity is set. Thus, the apple object is placed on the upper surface of the table object in the three-dimensional space. This means that the meaning of “upper” of natural language is understood. In this manner, the meaning of natural language is understood.

In this manner, a state where an apple is on a table is reproduced in the three-dimensional space of 3DCG. This can be the same situation that comes to mind when a person reads a sentence “There is an apple in contact with the upper surface of the table.” Next, the sentence “The apple is lifted upward” is input. When the meaning of this sentence is understood, “apple” is first determined to be an apple on the table in the current state. Then, since this apple is “lifted upward,” the apple is moved upward in the three-dimensional space of 3DCG. This process means that the meaning of “lifted upward” is understood.

If an instruction “Lift the apple upward.” is given to the robot, the robot understands the meaning and takes the apple on the table in front of the robot and lifts the apple upward. This means that the robot understands the meaning of natural language and can make a natural communication with a human.

Then, supposing that the foregoing process is understanding of the meaning of a text. A text is a series of sentences. In the first sentence, a scene in which an apple is on the table is created. First, a thing and a person to appear are created, thereby creating a scene. In a next sentence, the thing that has appeared is intended to be manipulated and moved. In this manner, understanding the meaning of a text can be expressed by manipulating setting of a scene and an object appearing in the scene and thereby changing the scene. A scene before the change and a scene after the change are stored so that a history of the past can be remembered. This corresponds to an episodic memory in terms of a memory of a human. Scenes are stored in the order of occurrence of events. A function for storing the scenes in order corresponds to time.

Here, consider a relationship between a three-dimensional space of 3DCG and an apple. This can be a relationship between a world and an object. Placing an object in a three-dimensional space means setting a location property of a thing. A relationship between a thing and a world is determined with this location property. The method “lifting upward” shows upward movement along a Z coordinate representing the upward and downward direction in a three-dimensional space. That is, if a location property of a thing is set by using X, Y, and Z coordinate axes, “lifting upward” means changing the Z coordinate axis. Further, a verb “moving” means changing a location property of a thing. As described above, the method means changing a property, and a verb of natural language corresponds to the method. That is, in understanding meaning of natural language, a thing is generated as an object, and a verb can be rephrased as changing a property of the object.

A relationship between objects can be defined by using properties, and a relationship between a table and an apple can be expressed as being separated by a distance obtained from a difference between location properties thereof In this manner, a relative relationship between things can be determined by using properties.

Next, consider the meaning of “Get an apple.” In this case, not a three-dimensional world but an owned space is considered. The owned space is a space expressing the meaning of owning a thing. An object placed in this world has a property of owing. In the case of “Mr. A gets an apple from Mr. B.”, for example, Mr. A and Mr. B are placed in the owned space, and first, an apple is in the owned property of Mr. B. Then, the verb “get” is exerted, the apple in the owned property of Mr. B shifts to the owned property of Mr. A. This is the meaning of “get.” From the standpoint of Mr. A, this event is “give.” In this manner, the meaning of “give” and “get” are realized with human objects and the owned space.

As described above, the meaning of a sentence of natural language can be expressed by a world or a space, an object placed in the space, and a change of property of the object. It can be said that this is understanding of meaning of a sentence of natural language. The space as used herein is not limited to a three-dimensional space. What defines a three-dimensional space is positional coordinates, but what defines an owned space is who owns a thing. The space as used herein is used for managing attributes of each object placed in the space. In a three-dimensional space, an object is managed by using an absolute location, whereas in an owned space, an owned relationship between objects is managed.

Consider a family relationship space as another space. In this case, a relative human relationship is expressed. The relative human relationship is that a partner to a self is father or son, for example. In a human relationship property of a human object in this case, a relative relationship between a partner and a self, and a relationship of the self changes depending on the partner. This is a family relationship space. Accordingly, it can be understood that “become a parent” means that a child is born.

As described above, it can be said that understanding of meaning of natural language is that an object is generated and a manipulation of, for example, setting or changing an appropriate property of the object is performed. It can also be said that a property belongs to a space or a world.

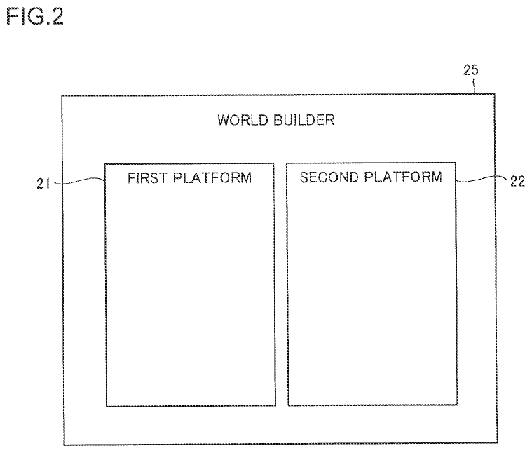

As illustrated in FIG. 2, the world builder 25 includes a first platform 21 and a second platform 22. On the first platform 21, an external world itself is reproduced as a virtual world by the world builder 25. For example, supposing the external world is in a room, a three-dimensional world is set on the first platform 21. Then, a table is recognized by capturing with the camera 14, a data model of a table is extracted from the database 17, a table object is created by the generator 24, and a table object is placed on the first platform 21 as the three-dimensional world.

In this manner, a room captured by the camera 14 is reproduced on the first platform 21. Since a table object is a three-dimensional object, the table object can be freely moved in the room. It can be said that this is the same as a table in the real world. That is, a situation in which an object can be freely manipulated in the same manner as a human imagines in mind is constructed. Then, the output determiner 27 recognizes the real world through the external world constructed on the first platform 21. That is, the output determiner 27 recognizes the external world constructed on the first platform 21 as the real world itself.

The second platform 22 of the world builder 25 is constructed and manipulated by the output determiner 27. It can be said that the fact that an object placed on the second platform 22 can be manipulated is that a simulation can be conducted by using the second platform 22. That is, the output determiner 27 can determine an optimum output thereof by simulation using the second platform 22. In other words, the output determiner 27 recognizes a world developed on the first platform 21 as the real world, and has a function as “consciousness” that determines an action through trial and error by using the second platform 22.

Objects disposed on the platforms 21 and 22 have two types: a subject such as a person; and the other things. The difference between the subject and the other things is whether the object has a so-called “mind” or not. The “mind” has emotions such as happy and sad, and has a function similar to that of the artificial intelligence program according to the present disclosure. The subject has a mind, and includes not only actual humans but also characters appearing in movies and novels, nonexistent characters, God, devils, and so forth. A world developed on the first platform 21 is not limited to a real world, but also a world seen in a movie or a world imagined from a novel. A feature of the world is being created based on external information and incapability of being directly changed by the output determiner 27.

A processing method in an artificial intelligence program using a humanoid robot will now be described. The robot is a humanoid robot with hands and feet, and can walk and hold a thing. The robot also includes a camera, a microphone, and a loudspeaker, and can communicate with a person by voice. These components are controlled by the controller 12 for controlling the robot.

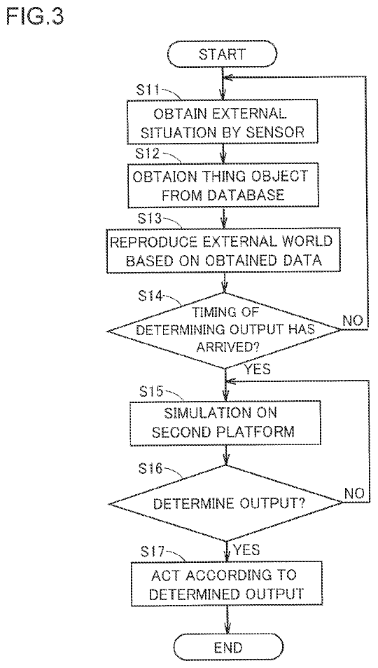

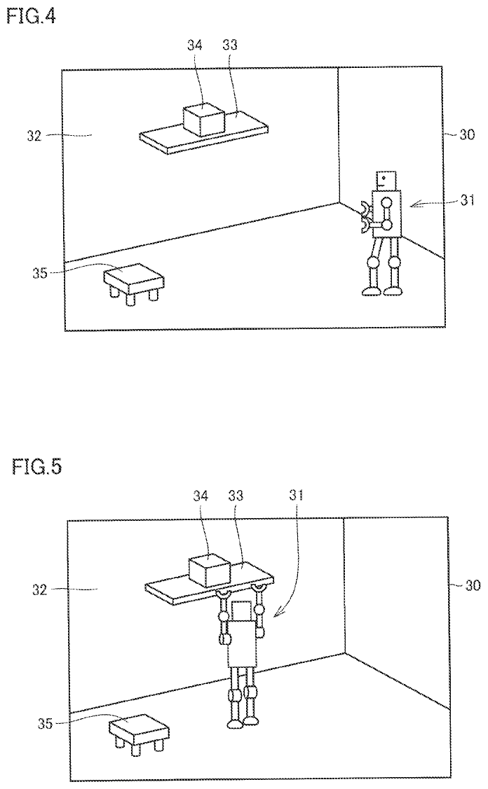

FIG. 3 is a flowchart depicting a typical process in processing by the artificial intelligence system 11 according to the present disclosure. FIGS. 4 through 6 are conceptual illustrations showing a second platform in which a robot 31 is placed in a room 30.

As illustrated in FIG. 4, a shelf 33 is attached to a wall 32 in the room 30 in which the robot 31 is placed. A battery 34 is placed on the shelf 33. A chair 35 is placed in the room 30.

Referring now to FIG. 3, it will be described how the robot 31 recognizes a situation. The robot 31 captures a situation of the room 30 by a camera, analyzes an image, and recognizes the shelf 33, the battery 34, the chair 35, and so forth. That is, the robot 31 obtains an external situation by sensors (S11). A database stores a large number of data models, and things recognized are extracted from the database 17, and objects of the things are created (S12). If an object is a thing, for example, the object has data such as shape and size, as three-dimensional data. In addition, the object is also associated with information of, for example, attributes and functions of the object, such as color and weight. That is, artificial intelligence can understand meaning. Understanding of meaning is that if “the height of a table” is specified, it is found that it corresponds to height data of the table object.

A data model is realized in a class in object-oriented language. The camera 14 corresponding to an eye of the robot 31 captures a real world in front of the robot 31, converts a captured image to three-dimensional data by image analysis in real time, and recognizes a thing from the shape thereof. If the thing is determined to be “chair,” a chair class is called, and a chair object is generated. This chair object is directly recognized by the robot 31. The chair class has legs and a seat, for example, as parts of the chair 35, and has three-dimensional data thereof. Then, the parts such as legs and a seat are set such that the parts coincide with three-dimensional data of the recognized chair 35. That is, based on obtained data, an external world is reproduced (S13).

A thing has attributes such as material, color, hardness. For the color of the chair 35 acquired by image analysis, a color attribute is set to the chair object. Similarly, if the material of the chair 35 is determined to be wood from data subjected to image analysis, wood is set as a material attribute of the chair object. Since data such as weight and hardness is recorded in the data model of wood, the weight and hardness, for example, of the chair object are set from the data. What is directly acquired by the camera 14 is only an image, but data that cannot be directly measured, such as weight and hardness, can be recognized in the manner described above.

A thing recognized by the camera 14 exists in a three-dimensional space of the real world. Thus, a thing object created from the data model also needs to be placed in the three-dimensional space. Here, a three-dimensional space in which a thing object is placed will be referred to as a three-dimensional virtual world, as compared to an external three-dimensional real world. The three-dimensional virtual world is constructed on the first platform 21 and the second platform 22 of the world builder 25, and is allowed to have a plurality of thing objects. The three-dimensional virtual world also has a function for manipulating a thing object. For example, as a placement function, the function has a location and a thing object as arguments. When a thing object and a location are passed, a specified thing object is placed at a specified location in the three-dimensional virtual world. As a movement function, the function has a thing object and a destination location as arguments, and a specified thing is moved to a specified location.

The three-dimensional virtual world and the data model are simulated as close to the real world as possible. In the real world, solid things do not overlap each other, and thus, when two balls collide with each other, these balls do not overlap but are bounced off and sound is produced upon impact. The three-dimensional virtual world is also programmed such that thing objects do not overlap each other, and when thing objects collide with each other, these objects are bounced off and sound is produced. As in the real world, gravity is also set. That is, downward gravity is always exerted vertically on a thing object. In this manner, the top-bottom direction can also be set in the three-dimensional virtual world.

In addition, time passes in the real world, and this is also realized by a program. Time can be expressed by a one-dimensional time axis flowing from the past to the present and to the future. A segment cut at the current moment is a situation developed in front of the robot. That is, a situation currently developed on the first platform 21 is the present recognized by the robot 31.

A situation in the three-dimensional virtual world at a given moment is stored as an event and such events are stored along the time axis. This is a story. In the story, a time flow is set in the direction from the past to the present. That is, in the story, management of scenes and events in chronological order corresponds to the idea of “time.” In a program, the story can be realized by a data structure such as an arrangement or a list, for example.

A place where the real world or a story is reproduced as a virtual world is the world builder 25. An external world reproduction unit 26 reproduces an external real world, and an output determiner 27 manipulates the world.

On the first platform 21, an external virtual world faithfully reproducing the current external world is developed. Based on information of an external situation from the camera 14 and the microphone 15, the world builder 25 generates an external virtual world on the first platform 21.

The thing object is constituted by an object of three-dimensional data, and thus, is theoretically movable in a virtual world. However, an external virtual world developed on the first platform 21 faithfully reproduces the external real world, and thus, when the chair 35 is moved only in the external virtual world, a divergence from the real world occurs. Thus, an object on the first platform 21 cannot be freely moved by the output determiner 27. In view of this, the second platform 22 is provided as a platform in which a virtual world different from the external virtual world can be developed. That is, the second platform 22 can be freely manipulated by the output determiner 27 (consciousness).

Supposing that the robot 31 works in an office, and a boss enters the room 30 now and says “Bring me the battery on the shelf” to the robot 31. The robot 31 determines that it was the boss who said by face recognition, converts the words to text data by voice recognition, and understands the meaning as the contents the boss said. In this case, the robot 31 understands the meaning that the robot 31 has been given a mission of bringing the battery 34 on the shelf 33 to the boss. That is, the robot 31 determines that the timing of determining an output has arrived (YES in S14).

The output determiner 27 searches for what action is to be taken in order to take the battery 34. The second platform 22 is used for the search. That is, simulation is performed on the second platform 22 (S15).

First, the output determiner 27 constructs a three-dimensional virtual world similar to the first platform 21 on the second platform 22. At this time, the robot 31 as a self is placed in the three-dimensional virtual world. In this manner, the output determiner 27 can determine an optimum action by simulating its own action on the second platform 22. That is, an output is determined (YES in S16).

Since an object is to take the battery 34, the robot 31 moves to the shelf 33 as close to the battery 34 as possible, and then reaches for the shelf 33 in order to take the battery 34 (see FIG. 5). Then, it is found that the robot 31 cannot reach the battery 34. That is, the height is insufficient.

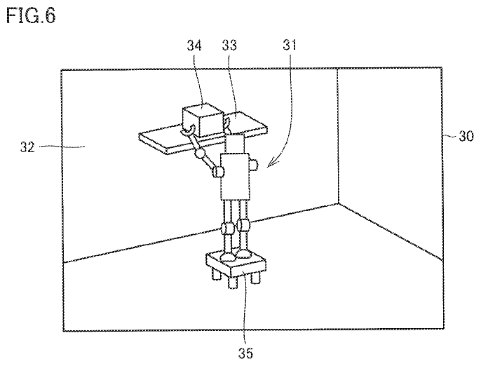

Then, a method for compensating for the height is searched for. The robot 31 has knowledge in the database 17, and searches the database 17 for a method for lifting up the robot 31 itself. Then, a method “put on the chair” is found. Thereafter, the robot 31 searches for a chair, and finds the chair 35 in the room 30. Subsequently, the robot 31 simulates a situation in which the robot 31 moves the chair 35 under the shelf 33 on the second platform 22 and the robot 31 rides on the chair 35. Then, it can be simulated that the robot 31 can reach the shelf 33 and take the battery 34 (see FIG. 6). Subsequently, it is simulated that the robot 31 gets off the chair 35 with the battery 34 and brings the battery 34 to the boss. If there arises no problem, a series of simulated actions of the robot 31 is recorded. Then, the robot 31 behaves according to the determined output contents (S17).

On the second platform 22, the robot 31 is placed and can recognize the robot 31 objectively. On the other hand, a subjective robot 31 is placed on the first platform 21. The subjective robot 31 is a state of itself currently obtained by the sensor thereof. For example, in a case where the camera 14 corresponding an eye captures a hand or a foot of the robot 31, or a case where a temperature sensor or a tactile sensor is provided on the hand or the foot, the state is data sensed by the sensor.

Although the current world on the first platform 21 cannot be manipulated by the output determiner 27 as described above, the body of the robot 31 such as the hands and feet and the loudspeaker 16 corresponding to a mouth can be manipulated by the output determiner 27. This is because when the output determiner 27 intends to rise a hand, the motor 13 in a hand of the robot 31 is driven so that the hand of the robot 31 in the external real world is raised. This situation is captured by the camera 14, and the hand of the robot 31 in the external virtual world on the first platform 21 is also raised.

Thus, an action determined through simulations is executed on the first platform 21 so that the robot 31 actually behaves in the real world and can carry out a mission of bringing the battery 34 to the boss.

In this manner, the artificial intelligence system 11 according to the present disclosure can determine an optimum action through simulations on the second platform 22. This is substantially the same as thought of a human.

In the foregoing description, the world and a data model (object) recognized by the output determiner 27 is a thing captured by the camera 14, but the data model is not limited to a thing that physically exists, and any thing recognizable by a person can be a data model. For example, consider a company organization. Positions such as section chief and general manager do not physically exist, and are concepts that exist in peoples' minds. Even such concepts can be recognized by the output determiner 27 using a data model (object) and a world where the data model is placed.

For example, supposing that a company organization virtual world simulating a company organization in the real world is created, the company organization virtual world has a structure in which a plurality of positions are arranged in the order of positions. An employee object as a data model of an employee in the real world is placed in a corresponding position in the company organization virtual world. The company organization virtual world has a promotion function as a function for manipulating the employee object, and when an employee object of chief clerk is promoted by one step, the object becomes section chief

Supposing that an acquaintance says “I became a section chief” If the robot 31 knows that he/she was previously a chief clerk, he/she was promoted, which means an elevation of the value of him/her. Thus, if the robot 31 replies “Good,” a meaningful conversation is established. This is understanding of meaning of words. Understanding the meaning enables the robot 31 to make a natural conversation with a person.

An external world is not limited to a world that exists in reality, and may be a world in a movie or a novel. In this case, a virtual world is also constructed on the first platform 21 from an image or text data captured by the camera 14.

A method with which a robot according to another embodiment determines an action using the artificial intelligence system 11 will now be described. The robot includes a sensor for detecting an internal state of the robot, as well as sensors for detecting an external environment, such as a camera and a microphone. Supposing that the robot 31 has a battery level detection sensor, as one of the sensors described above.

The artificial intelligence system 11 has positive and negative psychological states. The positive psychological states are favorable psychological states such as happy and full. The negative psychological states are unfavorable psychological states such as sad and danger.

The output determiner 27 receives information from sensors for detecting an external environment and an internal state, and includes a psychological state determination program for determining a psychological state. For example, if a battery level from the battery level detection sensor decreases below a lower limit, the state is determined to be a negative psychological state of hungry. If the battery level increases above an upper limit, the state is determined to be a positive psychological state of full.

When the output determiner 27 senses a negative psychological state such as a hungry psychological state, the output determiner 27 searches for an action for solving this state. The database has a cause-and-effect dictionary including pairs of causes and effects.

The cause-and-effect dictionary records a rule of “If A is done, B is established.” This is realized by managing pairs of causes and effects and recording the rule in a database. This cause-and-effect dictionary is a type of a long-term memory. An example of the cause-and-effect dictionary is “If you study, you will be smarter.” or “If you practice running, you will get faster.” Contents of the cause-and-effect dictionary are added through experience or learning. Here, the dictionary stores data such as “If the battery is charged, the battery restores.” or “If the battery is replaced by another battery, the battery restores.”

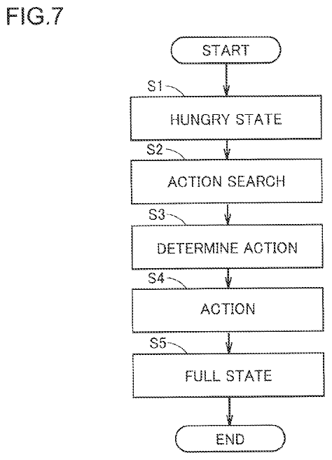

A method with which the output determiner 27 according to another embodiment determines an action will now be described with reference to the flowchart of FIG. 7. In step S1, when the output determiner 27 detects a hungry state of a psychological state determination program included in the output determiner 27, a negative psychological state is established.

When the output determiner 27 detects a negative psychological state, the output determiner 27 searches for an action for solving this state in next step S2. Supposing that two actions “If the battery is charged, the battery will be fully charged.” and “If the battery is replaced by another battery, the battery will be fully charged.” are obtained by searching the cause-and-effect dictionary of the database 17.

In next step S3, it is determined which one of obtained actions is selected. The output determiner 27 places an object of the robot on the second platform 22, and simulates the action obtained in step 2. The action involves motion such as movement and work and costs such as expenses. Supposing that the cost for charging is +5 and the cost for replacing batteries is +10 through a simulation. Data necessary for calculating these costs is stored in the database 17. The output determiner 27 selects an action at the lowest cost from the actions, and charging is selected in this example.

When an action is selected, an action according to the simulation is performed in next step S4. The first platform 21 is a model obtained by constructing the real world as it is, and is allowed to manipulate objects of the robot. An object of the robot placed on the first platform 21 is in cooperation with the motor 13 and the loudspeaker 16 that provide outputs to the outside. The output determiner 27 is configured such that when the object of the robot is manipulated on the first platform 21, the body of the robot in the external world actually moves. This corresponds to the primary motor area in human brain.

Thus, when the output determiner 27 applies the action selected in step S3 to an object of the robot on the first platform 21, the robot actually moves in the external real world and the battery can be charged.

When charging is actually performed and the battery level detection sensor exceeds the upper limit, the psychological state determination program becomes a full psychological state in step S5. Then, the output determiner 27 determines that the hungry psychological state is solved, and finishes the search for an action for solving hungry.

As described above, the artificial intelligence system 11 does not reply directly to the external world by sensors, but can act with simulations by constructing a virtual world in the system 11. This is a biggest advantage of the present invention.

To clarify this, consider a frog that directly replies to the external world. It is assumed that a frog recognizes a fly as food based on movement of a black point, and when the fly recognizes a fly on an empty stomach, the flog stretches its tongue and catches the fly. If an environment does not change at all, the flog can live with this program. However, if the environment changes to an environment where not a black fly but a red fly lives, the flog cannot catch the red fly and starve to death with the program in which the flog reacts only to a black point.

On the other hand, with a platform that can be simulated, even if the environment changes to a new environment, a new action in accordance with the new environment is generated and simulated and the action can be actually tried. Thus, even with a change of environments, the robot can flexibly respond to the change or make a plan and act. The human brain has this function, and the artificial intelligence system 11 according to the present invention also has the function.

The database 17 will now be described. The database 17 stores the shape, name, and color of a thing, for example. This corresponds to a semantic memory of a human memory. The semantic memory is a knowledge such as “apples are red” and “one year has 12 months.”

On the first platform 21, an event currently occurring in the real world is developed. When some emotion (psychological state) such as happy or surprise occurs, using this emotion as a trigger, a situation being developed on the first platform 21 at this time is stored as a story in the database 17. Thereafter, artificial intelligence system 11 develops the stored event on the second platform 22 and can recognize the event again. This can be “recollection” in the case of humans. The “recollection” is a memory of a type in which a scene appears as an image in the head, and is called an episodic memory. As described above, the database 17 stores not only a semantic memory but also an episodic memory. A section storing an episodic memory corresponds to hippocampus in human brain. The database 17 functions as a long-term memory that stores a semantic memory and an episodic memory.

The episodic memory can store not only a current world developed on the first platform 21 but also a world created (imagined) by the output determiner 27 and developed on the second platform 22.

The second platform 22 can be used not only for a past event but also the case of imagining a future event. On the second platform 22, “time” can be set, specifically, “yesterday” or “tomorrow” can be set.

While the output determiner 27 is not driven, during sleeping in the case of human, the artificial intelligence system 11 writes a common event in the episodic memory and repetitive events, for example, to the cause-and-effect dictionary and the semantic memory. If the output determiner 27 is constantly active, this process cannot be performed. In view of this, while the output determiner 27 is active for a long time, a desire (psychological state) to finish an active state of the output determiner 27 is provided. This desire corresponds to a desire to sleep in human.

The platforms will be additionally described. Specifically, advantages in reconstructing a world on the first platform 21 will be described.

For example, in a case where there are a table and a chair in front of the robot and images of the table and the chair are sequentially recognized by the camera 14, the table is first recognized, and then the chair is recognized. That is, the table and the chair, which should exist at the same time, are sequentially recognized in the order of the desk and the chair, and the world is not recognized as it is. This situation is constructed as a virtual world on the platform, and the output determiner 27 recognizes the virtual world. Then, the robot can feel the currently existing world as it is. That is, the world developed on the first platform 21 is a moment of “now.”

A world that is constructed on the first platform 21 or the second platform 22 and can be recognized by the output determiner 27 corresponds to a short-term memory or a working memory in a human. What is constructed on the platform includes not only a visible thing but also things undetectable by sensors, such as positions and money.

In a case where a past recollection developed on the second platform 22 and the “present” developed on the first platform 21 are held with a data structure that can hold a plurality of events and scenes in order, this data structure is “time.” Although “time” is not detected by sensors or the like,” when “time” is defined as an object that can be placed on a platform, “time” can be recognized by the output determiner 27. “Time” has a feature of passing only in one direction from the past to the present or from the present to the future in the real world. A cause and an effect registered in the cause-and-effect dictionary are managed in such chronological order that the cause is prior to the effect.

A method with which the output determiner 27 understands social implicit rules such as virtue and evil will now be described. For example, consider the following situation.

While walking in the park, I saw a little body crying. So, I asked “What's wrong with you?” He told me that a ball was caught on a branch and he couldn't get it off. So, I took the ball for him.

This is a very normal action, where I want to help a child who is in trouble. However, when I think about it, I wonder why it is natural for us to behave in this way. It would cause no problem if you don't feel anything and just pass by, but no one does not feel anything when a child is crying in front of them. When leaves of a tree swing due to a breeze, for example, it is common to pass by without any concern. What is the difference in psychology? There seems to be an implicit rule of society that “You should take a good action” in the background of this human psychology.

To implement this situation by a robot, the robot has to understand meaning of virtue and evil. However, this is unexpectedly difficult.

Since a robot can take a given programmed action, it is sufficient to program any “good” actions such as “If a child is in trouble, help the child.” or “Pick up any trash on the road.” However, there is no end in this case. Humans understand what is good and what is evil while living in society, even if they were not taught at all. They do not behave without being not taught all the good deeds and evil deeds.

In addition, humans don't act even when they know this is a good deed, and acts even when they know this is an evil deed. There is no simple correlation between virtue and evil and human action. That is, it is impossible to cause a robot to learn virtue and evil deeds through machine learning.

With respect to virtue and evil, attention is given not to a simple action but to a psychological state in the background. Then, it is found that a good deed is a psychological state of “should do.” That is, a good deed is a rule that the society has implicitly imposed on individuals, such as “should do.” Thus, the output determiner 27 is provided with a “should-do determination program.”

Here, the “should-do determination program” will be considered. First, subject objects of a self and a partner are disposed on the platforms 21 and 22, and the output determiner 27 determines positive/negative emotions of the self and the partner. In determining an action, the output determiner 27 basically determines that the self has a positive emotion. However, in acting in the society, the “should-do determination program” acts.

The output determiner 27 places objects of a self as a subject and a boy on the second platform 22, and simulates an action that the self can take. One action is to leave without doing anything, and the other is to help the boy. From this situation, the output determiner 27 calculates a positive/negative emotion of the self by, for example, numerical values. In the case of leaving, the subject has been walking in a park and continues to walk. Thus, no change occurs, and the numerical value is zero.

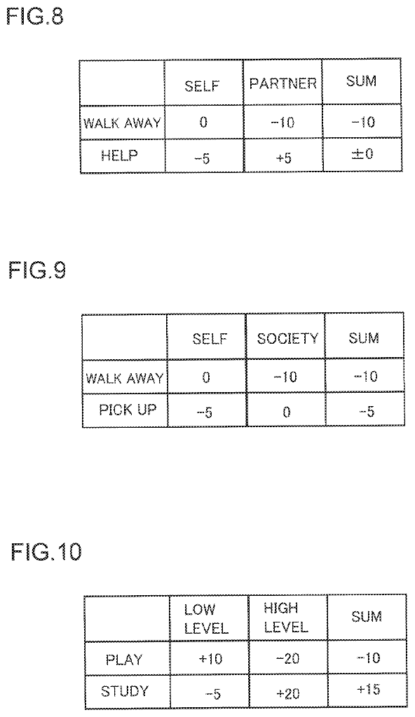

As illustrated in FIG. 8, in the case of helping the boy, the self calls him or does some work. Thus, effort and time are expected to be taken, and the output determiner 27 expects that a positive/negative emotion at this time is −5 (minus 5).

Since the output determiner 27 determines an action such that the positive/negative emotion of the self is at the maximum, when determining from these situations, an action of leaving is taken. However, the should-do determination program acts at this time.

If there is another person (partner) other than the self, the should-do determination program considers a positive/negative emotion of the partner. The positive/negative emotion of the partner cannot be detected by sensors or the like, and thus, are estimated from various situations. In this situation, the partner is “crying.” This situation of crying can be determined from the camera 14 or voice. The state of “crying” is registered as a negative emotion, for example, −10, in the database 17. It is expected that if the self helps the boy, the positive/negative emotion of the body increases by +5 (plus 5).

Then, the positive/negative emotion of the partner is set, and the output determiner 27 determines an action based on consideration (e.g., sum) of the positive/negative emotion of the self and the positive/negative emotion of the partner. Then, in the case of leaving, since the positive/negative emotion of the partner is −10, the sum is −10. On the other hand, in the case of helping the boy, the positive/negative emotion of the partner is +5 (plus 5), and thus, the sum is ±0 (plus-minus 0). That is, the value is larger in the case of helping the boy, and thus, an action of help is selected.

Through simulations, a situation where the output determiner 27 has a negative emotion of −10 in the case of walking away means that just thinking of walking away when someone in need is in front of the self causes an unpleasant emotion or a bad emotion. Of course, not only through simulations but also when actually walking away, the self feels unpleasant.

In this manner, when the output determiner 27 determines an action, the action can be biased such that a selfish action is suppressed and an altruistic action is taken. Accordingly, the output determiner 27 is realized to make a good deed such as helping people in need and being considerate of others. That is, the output determiner 27 determines an output based on the sum of quantified positive/negative emotions in a human object disposed on the second platform 22. Accordingly, it is possible to provide artificial intelligence that is more considerate of the partner and behaves as if having the same mind as humans.

There can be another type of good deed in the absence of a partner. For example, if there is an empty can in a park, an action of picking it up and putting it in a trash is a good deed. Consider this case.

As illustrated in FIG. 9, a positive/negative emotion of the self when walking away is zero because the self does nothing, whereas a positive/negative emotion when the self picks up an empty can is −5 because labor is involved.

Next, supposing that it is recognized that there is an empty can. An empty can is a type of trash, and is determined to have a negative value from a semantic memory. When a thing with a positive/negative value is recognized, then consider the value to society in that case. The society in this case is, for example, residents using the park. When a positive/negative emotion of a person is estimated, the emotion is −10 in the presence of trash and is zero in the absence of trash.

Then, the sum is −5 in the case of picking up trash, and is −10 in the case of not picking up trash. The sum is larger in the case of picking up trash, and an action of picking up trash is taken. In this manner, even in the absence of others, a good deed is selected by assuming local residents and society.

As described above, actional decision of the self is corrected by assuming positive/negative emotions of subjects other than the self so that it is possible to realize ethics such as virtue and evil without storing an infinite number of good and even deeds.

The value of a positive/negative emotion set by the output determiner 27 or the should-do determination program is not fixed and varies among robots, and constitute characters of the robots. For example, if a robot tends to set a positive/negative emotion of a partner high, the robot has an altruistic kind character, whereas if the robot tends to set its own positive/negative emotion high, the robot has a selfish egocentric character.

Next, “should do” in the case of being none of virtue and evil will be described. For example, when a parent says to their child “Don't play around. Study.”, the parent thinks that “the child should study rather than play” in the background. This “should study” is neither social good nor evil. This is not social but relates to individuals.

Here, positive/negative emotions of individuals are divided into a low level desire and a high level desire. The low level desire is readily available at low costs, and to put it simply, is bodily and physical, and is typically a desire based on instincts. That is, the low level desire is a motive force of an action by instincts of animals seeking comfort. Specifically, the low level desire includes appetite, sexual desire, desire to sleep, desire for reassurance, desire for safety, and desire for ease. A readily available short-sighted desire is also included in the low level desire. Examples of the short-sighted desire include games, gambling, luxury items such as alcohol, cigarette, and coffee, and drug.

The high level desire is a desire to obtain a state more valuable than others in comparison with others or in society, and cannot be obtained without using a long time or a high cost. The high level desire is, for example, a desire to obtain a social position such as president, doctor, politician, professor, professional athlete, singer, entertainer, celebrity, high income earner, or highly educated people. The high level desire is not limited to such general social positions, and includes a valuable status or an increase in status in small community of, for example, school, such as winning an athletic event or being praised by a teacher for a drawing.

Thus, when individual positive/negative emotions are divided into a low level desire and a high level desire, it can be said that an individual “should” select the high level desire rather than the low level desire. In short, you should put up with what is easy for the time being and should do what will help your growth in the long run.

Consider a case where getting into a high-level university satisfies the high level desire. This can be estimated by using a cause-and-effect dictionary. For example, from the cause-and-effect dictionary, causes and effects are linked in such a manner that “Study hard, and you will get smart.” and “If you smart, you can enter a good university.” Then, as an action that you can currently take in order to enter a good university, “study” is obtained.

The low level desire has two types: a type that can be detected by a sensor such as hungry or a battery level; and a type that comes from inside such as desire to play or to drink. The world builder 25 generates such a desire to play coming from the inside, as a low level desire of this person.

The output determiner 27 tries to take “study” to enter a good university, but in contrast, feels a low level desire to “play.” The output determiner 27 determines an action from two options “play” and “study.”

If “play” is selected, the robot feels joy and the low level desire becomes +10, for example, but the high level desire becomes −20, for example, because of inability to study, lower test score, or failure in entering a good university in future, and the sum becomes −10. On the other hand, if “study” is selected, the robot cannot play right now, and the low level desire is not satisfied and becomes −5, for example, whereas the high level desire becomes +20, for example, because of higher test score and ability to enter a good school, and the sum becomes +15. Thus, an action of “study” is selected. In this manner, an action for suppressing the low level desire and satisfying the high level desire can be promoted. This is a “should-do program.” Parameters set vary depending on characters and experiences, which constitute personality. That is, the robot can be a robot easily influenced to an easy side or an unemotional robot.

To consult with others about their worries, you must understand the meaning of the worries, and if you cannot understand the implicit rule of “should do,” you cannot understand the worries such as “I want to play but I have to study.” and a conversation is not established. The artificial intelligence system according to the present invention can understand the meaning of such “should do,” and thus, can make a natural conversation with a person.

An emotion of “should do” is an emotion common to people living in the same society. Conversely, any person having this common emotion can be accepted as a member of this society. One of such emotion is a virtue and evil rule.

In movies and novels, AI only makes a theoretically correct action, and does not feel a human mind such as sympathizing with the emotion of others. The artificial intelligence system according to the present invention can take natural actions such as caring for others' emotions and what to do, and will be naturally accepted by society.

The low level desire and the high level desire can be considered as follows. A human object imitates a human and includes desires and emotions of humans as programs. For example, as an attribute, the degree of hunger, for example, is included as a numerical value in a hunger degree property. As a method, an action of “eat” is included. These are associated such that if the hunger degree property increases, a desire to eat increases. This is an appetite. The appetite is a motive force of an action for desire to eat, and the degree of hunger and a desire are associated such that the degree of desire to eat is proportional to the hunger degree property. In this manner, appetite can be reproduced by a computer program. Some human desires occur based on the body and instincts, such as sleep desire and sexual desire, as well as appetite. Such desires dependent on the body, that is, in a case where a subject is a robot, a desire required for maintaining the state of the robot itself as a thing will be referred to as a low level desire. The subject is not limited to a robot, and may be a human object generated on a three-dimensional space such as 3DCG, or on the first or second platform.

Human desires include desires dependent on society as well as desires dependent on body. For example, society includes classes, and there generated a desire to achieve a high status in the society to which one belongs. Specifically, the desire is to be promoted from section chief to general manager in a company, to be a benchwarmer to a regular member in a club activity, to enter a school with a high deviation score, and to be a prime minister in a nation. In every society, there are high and low classes or statuses in any society, such as a position in a company, a deviation score, and so forth, and a social desire is to achieve a high status in the society. The degree of social desire is determined in relation to a difference between a current position and a target position and personality. This social desire, that is, a desire that cannot be directly obtained to maintain the state of a thing itself will be hereinafter referred to as a high level desire.

A more complicated psychological situation will now be described. People have various psychological situations from emotions such as “happy” and “sad” to complex emotions such as “regret” and “jealousy” and ethics such as virtue and evil, and a conversation is established by understanding a psychological situation of a partner. If the partner is happy, a reply “That's good.” is made or if the partner is sad, a reply “That's sad.” is made. Then, the partner feels that his/her emotions has passed. This is a daily conversation.

That is, a most important thing in daily conversation is to understand a psychological situation of a partner. Making a reply in accordance with this psychological situation is a daily conversation.

Next, an analysis method of a psychological situation as a psychological pattern will be described.

First, a psychological pattern of “patience” will be described. In the description above, study is selected from play and study. A force from the “should-do program” acts to suggest the high level desire rather than the low level desire, and a situation where the low level desire is suppressed at this time can be defined as “be patient.” The “be patient” refers to a psychological pattern that suppresses a desire mainly from the body, such as sleepy and painful.

When the high level desire is selected rather than the low level desire, a psychological pattern focused on the low level desire is “patience,” whereas a psychological pattern focused on the “high level desire” is “work hard” and “strive.” For example, in an action of “study,” the low level desire is minus, and thus, is an unwanted action. However, a high level desire when achieved is high. This is because an action for the high level desire is performed with the low level desire is suppressed for a goal. This is a psychological pattern of “work hard” and “strive.” In a situation of running in a marathon, for example, a low level desire to rest is suppressed and an action for a high level desire of continuing running in order to aim for a goal. Thus, a psychological pattern of “work hard” is present.

For those who are in such a situation, a cheer “Hang in there!” is given. This is a psychological pattern of “cheering.” Cheering is words of call that affirms and encourages an action for a high level desire selected by a partner in a case where a psychological pattern of the partner is recognized to be “work hard.”

Then, a psychological pattern of “regret” will be described. First, “regret” needs a goal. The goal is a high level desire to be a kind of person you want to be in future, such as passing a university entrance examination. “Regret” occurs in a case where the high level desire is not achieved and attention is given on a past action that would have achieved a goal if the past action had been changed. To understand this, a hypothesis “if” needs to be understood.

To understand a hypothesis, the second platform 22 is used. Consider a case where one failed a university entrance examination and regrets that he/she should have studied harder. First, a past self is disposed on the second platform 22, and a case where an action that should be taken, which is study in this case, is selected among possible actions is simulated. A cause-and-effect dictionary stores information that “If you study, you will be smarter.” or “If you smart, you can enter a good university.”, and it can be simulated that studying enables passing a university entrance examination. The output determiner 27 compares passing a university entrance examination obtained by the simulation result with an actual failure in an entrance examination, and recognizes that the cause is in selection of an action “not study.” That is, the artificial intelligence system 11 compares reality with simulation, and when finding a past action causing the failure, generates a regret psychological pattern of “I should have studied harder.”

In a case where it is determined that a partner regrets by imagining not only a psychological pattern of a self but also a psychological pattern of the partner, saying “I'm sorry to hear that.” or “You should have studied harder” to the partner establishes a conversation.

A psychological pattern of “excuse” will now be described. The “excuse” is a psychological pattern occurring in a case where a high level desire as a goal was not achieved. Although “regret” is a psychological pattern of reflecting that the self is a cause of the failure in achieving the goal, “excuse” assumes that the cause of the failure in achieving the goal is others. For example, a cause of the failure in examination is “I couldn't concentrate on study because the house next door was too noisy.”

In the case of “regret,” the cause is the self, and thus, a negative emotion occurs, whereas in the case of “excuse,” the cause is others, and thus, no negative emotions occur. As described above, even in the same result, various psychological patterns occur depending on personality, and the reply varies depending on personality. This is the reason for failing to obtain a right answer even if a large amount of conversation data is collected and leaned by machine learning.

A psychological pattern of “pride” will now be described. The “pride” is a psychological pattern in which when a self satisfies a high level desire, the self represents this to others. A high level in the high level desire means socially valuable, and is created by comparison with others. That is, it can be said that the self is socially valuable. Intentionally showing this to others not satisfying the high level desire provides a satisfied emotion and an action of increasing a positive emotion. This is a psychological pattern of “pride.”

“Jealous” and “envious” are psychological patterns opposite to “pride.” That is, these are negative emotions occurring when the self knows that a high level desire that the self wanted is obtained not by the self but by others.

Then, a psychological pattern of “shame” will be described. A high level desire is a desire to be worth more than a given value in society. In other words, being less than the given value can be an ordinary presence. If the value further decreases to be below a given level, the value is inferior to ordinary. “Shame” is a psychological pattern when the value decreases below this given level. This level is determined depending on society to which one belongs. For example, in a track and field club, running 50 m in six seconds is normal, and seven seconds or more is “shame.” This is not clearly demonstrated, and exists as an implicit rule in this society, and there are various standards such as fashion and capacity. To understand the rule and maintain a minimum standard can be a minimum condition for being accepted by the society. It is essential to understand a psychological pattern of shame as artificial intelligence accepted by society.

A psychological pattern such as “win” and “lose” will now be described. Prior to this description, the idea of “competition” will be described. “Competition” is not a psychological pattern and is an idea, and is placed on a platform and can be recognized by the output determiner 27. The idea of competition is a situation where two subjects compete with each other. To compete is an action for determining which one of them is superior. The number of competing subjects is not limited to two, and may be three or more. The content of subjects is not limited to one, and the content may be a group, a team, or a country as a group of people. A competition is an idea established in a situation such as sports, war, and game.

On the platform, competitive ideas can be placed, and two subjects are placed and compete against each other according to a rule for determining which one of them is superior. A subject determined to be superior is “win” and a subject determined to be inferior is “lose.” “Win” is a positive emotion, and “lose” is a negative emotion.

Next, “allegory” will be described. For example, consider the term “examination war.” “Examination” does not involve killing and is totally different from war. However, “war” and “examination” are the same in terms of competition, and both belong to a “competition” idea. Then, by comparing “examination” with “war” through the competition idea, fierceness of examination is emphasized as being like a war. When “examination” and “war” are placed as competition ideas on the second platform 22, the output determiner 27 for recognizing these ideas can realize a fierce image of “war” onto “examination.”

As described above, expression of allegory can be understood using a psychological pattern. This is because understanding of allegory is most difficult in conventional natural language processing.

Other embodiments of the present disclosure will now be described. Supposing that the artificial intelligence system according to the present disclosure reads the following story and replies to questions. The story is as follows.

“There are Mr. A and Mr. B in a room. Mr. A has a basket, and Mr. B has a box. Mr. A has a marble. Mr. A puts the marble in his basket. Mr. A went for a walk outside. Mr. B takes the marble of Mr. A from the basket, and puts the marble in the box of Mr. B. Mr. A comes back. Mr. A wants to play with the marble of Mr. A. Here is a question. Where does Mr. A look for the marble?”

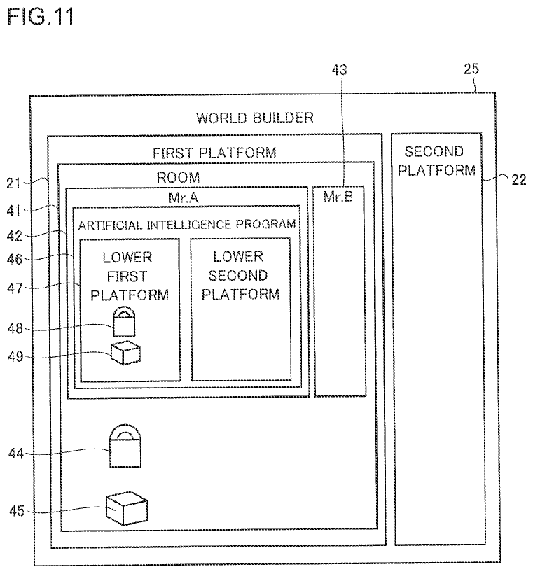

The generator 24 reads this story, and generates a virtual world on the first platform 21. First, as illustrated in FIG. 11, a data model of the room 41 is generated and disposed on the first platform 21. Then, two objects of Mr. A 42 and Mr. B 43 are disposed in the room 41, and objects of a basket 44 and a box 45 are also disposed in the room 41. This state is a first scene.

Next, a scene in which Mr. A 42 is put a marble in the basket 44 is realized in the virtual world. A scene with motion and change is defined as an event. In a next event, Mr. A 42 does out of the room 41. In the following scenes, Mr. B 43, the basket 44, and the box 45 are disposed in the room 41. In this manner, the story is managed as a series of scenes and events.

When the entire story is read in the manner described above, in the last scene of the virtual world on the first platform 21, the marble is placed in the box 45. Here, supposing that a question of “Where does Mr. A look for the marble?” is given. In the virtual world on the first platform 21, since the marble is placed in the box 45, the answer is “search inside the box” if nothing is done.

However, when the marble is moved from the basket 44 to the box 45, Mr. A 42 is outside and does not know the movement of the marble. Thus, the correct answer is “search inside the basket.” Thus, to answer the question correctly, a person set on the first platform 21 is provided with an artificial intelligence program 46. In this case, Mr. A 42 disposed on the first platform 21 has the artificial intelligence program 46 as illustrated in FIG. 11. The artificial intelligence program 46 has a lower first program 47 as a first platform for Mr. A 42. Based on information obtained from the outside by viewing or hearing, Mr. A 42 constructs a world that Mr. A 42 believes to be real, on the lower first program 47.

Here, since Mr. A 42 puts the marble in the basket 44 by himself and then went out of the room 41, Mr. A 42 does not see that Mr. B moves the marble to the box 45 thereafter. That is, the marble on the lower first program 47 to Mr. A 42 remains in the basket 48. The question is “Where does Mr. A look for the marble?” This is a question that a person should answer in the position of Mr. A 42. That is, it should be determined not from an actual situation in the real world but from a situation that the artificial intelligence program 46 of Mr. A 42 believes to be real. This is the virtual world constructed on the lower first program 47 of Mr. A 42, where the marble is not in the box 49 but in the basket 48. Thus, the place where Mr. A 42 searches is “basket.”

In the manner described above, the artificial intelligence program is also disposed, that is, an artificial intelligence program is also constructed in a nested structure, in a subject (human object) disposed on the first platform 21 so that the artificial intelligence program can think in the position of the partner and has a more human-like mind.

As described above, a mechanism to think from the other's point of view is proposed as a “theory of mind” and can also be capacity that only humans can have. When the lower first platform is employed, the “theory of mind” can also be realized.

The nested structure is not limited to double, and may be to any depth such as triple and quadruple. However, because of an enormous calculation amount, the configuration is preferably limited to a double, or triple at most, nested structure.

It should be understood that the embodiments disclosed here are illustrative and non-restrictive in every respect. The scope of the present invention is defined by the terms of the claims, rather than the description above, and is intended to include any modifications within the scope and meaning equivalent to the terms of the claims.

### DESCRIPTION OF REFERENCE NUMERALS

11 artificial intelligence system, 12 controller, 13 motor, 14 camera, 15 microphone, 16 loudspeaker, 17 database, 18 control unit, 21 first platform, 22 second platform, 24 generator, 25 world builder, 26 external situation reproduction unit, 27 output determiner, 30 room, 31 robot, 32 wall, 33 shelf, 34 battery, 35 chair, 41 room, 42 Mr. A, 43 Mr. B, 44, 48 basket, 45, 49 box, 46 artificial intelligence program, 47 lower first platform.

1. An artificial intelligence system configured to determine an output to outside based on information input from the outside, the artificial intelligence system comprising:
a storage configured to previously store a data model imitating a human and a thought of a human;
a generator configured to extract the data model from the storage and generate a human object capable of reproducing a motion and a thought of a human;
a world builder including a first platform and a second platform and configured to construct a world in which a motion and a thought of the human object are developed, the human object being disposed on the first platform and the second platform;
the external world reproduction unit configured to dispose the human object on the first platform and reproduce an external world, based on the information input from the outside; and
an output determiner configured to obtain an external situation by recognizing the external world reproduced on the first platform, dispose the human object on the second platform, and determine an output to the outside by manipulating the human object.

2. The artificial intelligence system according to claim 1, wherein
the human object of each of a self and a partner is disposed on the first platform and the second platform, and
the output determiner determines an output such that a thought of the human object of the partner is felt favorable.

3. (canceled)

4. The artificial intelligence system according to claim 1, wherein
the data model of the human has two types of desires, the two types of desires being a low level desire generated from body and a high level desire to achieve a socially valuable thing, and
the output determiner determines an output such that the low level desire is suppressed and the high level desire is satisfied.

5. (canceled)

6. A natural language processing system including an input device configured to receive a sentence of natural language, a storage device configured to store an object representing a human or a thing, and a controller configured to disassemble an input sentence from the input device to words and analyze meaning, wherein
the storage device stores the object and a name of the object in association with each other, and
the controller generates the object based on the words of the input sentence and the storage device and changes the object based on the words of the input sentence to thereby analyze meaning.

7. An artificial intelligence system comprising:
a storage device configured to store a data model of a subject having a positive/negative emotion and determining an action of a self;
a controller configured to generate the data model of the subject of the self, and to determine an action of the self so as to have a positive emotion, wherein
the controller includes a should-do determination program that determines the action in consideration of a positive/negative emotion of another person.
